(19) United States
(12) Patent Application Publication
(10) Pub. No.: US 2013/0088452 A1
(43) Pub. Date: Apr. 11, 2013

(54) DEVICE CONTROLLER WITH CONNECTABLE TOUCH USER INTERFACE

(71) Applicants: Karlheinz Glaser-Seidnitzer, Fuerth (DE); Stephan Nufer, Erlangen (DE)

(72) Inventors: Karlheinz Glaser-Seidnitzer, Fuerth (DE); Stephan Nufer, Erlangen (DE)

(21) Appl. No.: 13/644,991

(22) Filed: Oct. 4, 2012

(30) Foreign Application Priority Data
Oct. 4, 2011 (DE) 102011083957.7

(51) Int. Cl. G06F 3/0488

(52) U.S. Cl. CPC G06F 3/0488
USPC 345/173

(57) ABSTRACT

In an electronic, context-sensitive controller system for a medical technology device, at least one external input and output device, with a touchscreen user interface, is provided with an adapter module. The medical technology device is operated and/or controlled via a computer-assisted application in order to exchange data with a control module. An interface between the adapter module and the control module is designed to exchange control data for control of the medical technology device via the touchscreen user interface of the external input and output device.

### BACKGROUND OF THE INVENTION

1. Field of the Invention

The invention is in the fields of medical technology and information technology and relates in particular to the control of computer-based medical technology devices, such as for example imaging systems in the field of radiology (computed tomography, magnetic resonance systems, mammography systems, etc.) or in the field of nuclear medicine (e.g. SPECT or PET systems) or comprehensive storage systems (RIS, Radiology Information System, PACS—Picture Archiving and Communications System).

2. Description of the Prior Art

In modern medicine most medical technology systems, devices and apparatuses (many laboratory devices, anesthesia devices, devices for recording physiological parameters etc. as well as the imaging devices) are based on digital information processes and are thus computer-based. As a rule they are operated via a user interface or other input and output devices, such as a monitor with keyboard and mouse for example. It is precisely in everyday clinical activities that it proves advantageous for the software for controlling these devices to be able to be operated with a graphical interface which is robust and durable and can be operated easily and quickly, especially under particular conditions, such as in the operating theatre for example. In such situations, touchscreen interfaces or touch user interfaces have been shown to offer very good opportunities for enabling the device to be controlled quickly and efficiently in the respective clinical field of application.

It is known that specially adapted external input and output devices can be connected to the system. Low-cost input and output devices can be obtained from different manufacturers, e.g. from Wacom or Logitech. It is a disadvantage, however, these input and output devices cannot be used unmodified for control of the medical technology application, but still need to be adapted (the medical application also must be adapted as well, by adapting the driver for example), which has been associated with additional expense and was therefore not done as a rule. Context-sensitive control of the I/O functionality by external devices (e.g. iPad or android cellphone) was not possible. A disadvantage of the previous systems is thus that they have unsuitable input and output devices that are able to be connected to the medical device without modifications.

### SUMMARY OF THE INVENTION

An object of the present invention is to provide a solution with which external input and output devices can be connected into a medical technology system as a user interface for controlling the system and, when this is done, to take account of the context of the application. The solution should enable an optimally adapted input and output device to be connected for a specific control task or for a specific medical device in order to control the application or the medical device. In such cases, the external input and output device should be able to be connected in a rapid, simple and uncomplicated manner.

The invention is described below on the basis of the controller system. Embodiments, alternate solutions, further features and advantages mentioned in this description are likewise also to be transferred to the other solutions of the stated problem (i.e. to the other forms of claim, such as to the method and the computer program product). Accordingly the sub-claims which are formulated and claimed in conjunction with the controller system can also be transferred to the method and the computer program product and vice versa. In such cases it should basically be taken into account that in each case the functional features of the method can be implemented by corresponding components of the system, by hardware modules or by microprocessor modules, with the corresponding modules being embodied to take over the functionality of the method steps. It is of no significance for the implementation of the inventive solution whether the concept is implemented as software or as hardware.

In accordance with an aspect of the invention, an electronic, context-sensitive controller system for a medical technology device has:
at least one external input and output device, which includes an adapter module,
the medical device, which will be operated or controlled by a computer-assisted application, wherein the application is exchanging data with a controller module,
an interface between the adapter module of the external input and output device and the controller module of the application for exchange of controller data for context-sensitive control of the medical technology device via the external input and output device.

The terminology used within the context of this application will be explained in greater detail below.

The medical technology device (also referred to synonymously as the medical device below) involves imaging devices which can be used for diagnostics, in the field of angiography or ultrasound for example, but also known systems such as computed tomography, magnetic resonance scanners, mammography systems or nuclear medical systems, such as PET systems or SPECT systems for example. The term medical technology devices likewise encompasses radiotherapy devices such as for example a linear accelerator with its components and with its imaging systems for displaying anatomy, soft tissue, markers and tumors as well as their changes in real-time. A further area of application is urology, with flat panel detector system or lithotripters etc. In addition to these complex systems, medical technology devices also include simple types of device, such as laboratory devices or devices for recording physiological data of the patient (blood pressure measurement devices, integrated temperature measurement devices, blood sugar measurement devices, photometers, centrifuges, microscopes, mini incubators etc.). These devices are either entirely or partly computer-based and must be operated or controlled via a computer-assisted application.

The term “external input and output device” is intended to indicate that the input and output device is not the type of input and output device that is usually connected to the medical technology device (such as a monitor with keyboard and mouse connected to the computer on which the application runs for example) but involves an external input and output device, which must be connected to the medical device via an interface. The input and output device thus involves one or more external input and output device(s) which is or are not connected to the medical technology device as such. For this reason it is referred to as an “external” input and output device. The input and output device is usually an electronic component or an electronic device having a touch-sensitive or touch-response user interface, a so-called touchscreen. These devices are also referred to as touch user interface input and output devices. The input and output devices are characterized by a touchscreen or a touch-sensitive screen which serves as a combined input and output device. The input and output device can also be embodied as a multitouch device. Usually the touchscreen is a component of a more comprehensive electronic device. For example the electronic external input and output device can involve a mobile radio device, which includes a touchscreen or a touchpad.

The touchscreen or touchpad of the mobile radio device then serves as an external input and output device for control of the medical technology device, in that the adapter module and the control module are provided for coupling the two devices.

The external input and output device can be provided as a solitary individual device or a number of input and output devices can be employed in parallel, for example in the sense of a multi-monitor environment.

The touchscreen of the input and output device can be based on various technologies. A resistive touchscreen can be provided, in which a signal is generated by pressure on the surface of the screen, which in its turn establishes a connection between the two electrically-conductive layers. The touchscreen can alternatively be based on capacitive technology, in which a voltage is applied to layered metal oxide layers in order to generate an even electrical field. Pressing on the screen changes the capacitance of the capacitor and generates a signal. A third option is the provision of an inductive technology for the touchscreen, in which however an operating element is needed into which a coil has been integrated. By moving the coil element over a specific position above the touchscreen a current is induced at the specific point, which is used for signal generation.

The adapter module is implemented on the external input and output device and is used for automatically adapting the touch user interface to the respective application via which the medical technology device is to be controlled. The adapter module preferably is formulated as a software module and is used for control or adaptation of the existing touch user interface with the respective application. The adapter module can be provided as an add-on module and/or be obtained as a download from computer-based server entities. In addition it is possible to read in and install the adapter module via a specific interface.

The medical technology device is operated and/or controlled via the application, which is preferably at least partly computer-assisted. In other words all necessary inputs, which are necessary for example to control a magnetic resonance system, are entered and handled by the application. Conversely, all data of the magnetic resonance system which must be notified to the user is presented by the application and its user interface. In accordance with one aspect the application is used for operation of the medical technology device. For example the presentation and processing of the image data on the monitor can be controlled via the application if the application is used for diagnosis of medical image data. In accordance with a further aspect the application is used for control of the medical technology device. If for example the medical technology device is a laboratory device for recording physiological patient data, the type of patient values to be received, the duration of the recording process and memory modalities can be controlled by the application. In accordance with a further aspect the application can be used for operating and control of the medical technology device. In accordance with the invention the application is exchanging data with the control module. For example the control module is embodied as a software application and can be added to the application as a further module. As an alternative, the control module is provided as a separate module, which the application can access when it needs to and vice versa. The control module is used for automatic adaptation of the application to the external input and output device to be connected. The control module serves together with the adapter module for context-sensitive coupling of the external input and output device to the application or to the medical technology device.

In accordance with the invention, an interface is provided between the adapter module (of the external input and output device) and the control module (of the obligation). The interface preferably serves exclusively for exchange of controller data for context-sensitive control of the medical device via the touchscreen of the external input and output device. In this embodiment no other data is exchanged by the interface. This has the advantage of enabling a security barrier to be set up, in that the input of malware (e.g. in the form of viruses, trojans etc.) over this interface to the medical technology device can be excluded. The interface is bidirectional. Preferably this involves a wireless communication link which can be based for example on an Internet protocol (for example IPv4, IPv6, or at the application layer, on the HTTP, IMAP, SMTP or DNS protocol). As an alternative a radio link, especially a mobile radio link, an infrared interface or a Bluetooth interface can be provided. In one variant the interface can also be a hardwired link. For example the hardwired link (e.g. cable link) can be used at least some of the time, such as to exchange higher volumes of data.

The controller data involves digital data which is generated as input and output data by the application or is requested by it as input variables. In an embodiment of the invention the controller data can also include metadata, which is exchanged between adapter module and control module and which for example provides information about the touchscreen and/or about the medical technology device. For example information can be transmitted with the metadata as to which functionality the user interface needs to be able to control the medical technology device to the full extent. Likewise specific device parameters of the input and output device can be displayed as meta information at the application in order to inform the user for example about specific configurations of the external input and output device.

In accordance with a preferred embodiment the adapter module is implemented on the external input and output device, while the control module is implemented on the application. In accordance with one variant adapter module and/or control module can also be held on central server entities, which the external input and output device and the application then access. As an alternative the adapter module and/or the control module can also be provided as part of a microprocessor solution and thus be hard wired, while other module parts are embodied as software. All or selected parts of the modules mentioned here can be implemented as software. Usually they are binary-coded and are present in digital form. The same applies to the method. In the method all sections or individual sections can also be provided as source code, as compiled code or as interpretable code (e.g. with a JIT compiler). It is of no significance for the inventive solution in which programming language the software is available (e.g. in C++, Java, Perl or PHP etc.). The important aspect is that both the adapter module and also the control module or the corresponding steps of the inventive method are part of the technical system and are bound directly into the technical system and are used there for control of the medical technology device or are intended to bring about the connection of a touchscreen of an external input and output device. Thus both the adapter module and also the control module interact at least indirectly with the technical devices (either with the electronic input and output device or with the medical technology device). Preferably however the adapter module and the control module are embedded into the medical technology system. They can also be provided as a so-called “embedded system” and already be delivered as an additional functionality with the respective devices.

In accordance with an advantageous development the controller system includes a detection module. The detection module is an electronic component or can preferably also be a software implementation. The detection module is used for automatic detection of an external input and output device in the interface area of the control module. In other words the detection module automatically recognizes if an input and output device is being moved in the interface area of the control module. In this case a registration process of the input and output device can be activated automatically. The registration process is based on the exchange of digital data and preferably comprises an authentication. The authentication can be carried out in accordance with the challenge-response principle, as is known from smartcard communication. The registration process or the registration procedure serves to register or sign on an external input and output device with the application, so that it can subsequently be used as an input and output device for control of the medical technology device. In one variant there can be provision for only a pre-selection of input and output devices to be permitted for registration. For example it is possible for a validity check to be carried out in advance and for only input and output devices confirmed as permitted to be able to be registered. In one variant there is provision for there to be an immediate notification on a previous output device (e.g. a monitor of the application) if a “new” input and output device is located in the interface area and/or has been registered. If other external input and output devices of the application have already been connected, a setting can be made such that the presence of a new, registered input and output device is signaled on all original and connected input and output devices.

In order to increase safety and avoid impermissible user inputs by input and output devices that are not permitted, there can be provision for the connection of an external input and output device to also have to be confirmed at the previous interface of the application. This can be done by a confirmation signal which is entered via a user interface of the application and/or of the medical technology device. This allows it to be preset that registered input and output devices additionally still have to be confirmed for connection by the application or by the medical technology device.

In accordance with an aspect of the invention, a number of external input and output devices can also be connected in parallel to the medical technology device. These input and output devices used in parallel are synchronized in such cases. This can be achieved for example by them exchanging data with one another via the same interface. An alternate solution makes provision for a semaphore principle to be followed, in order to define in the application for example which input device (of a number of registered devices) only has “read rights”, i.e. will only be updated in context, and which device additionally also has interaction rights. It is also conceivable for each input device to be handled in the same way and for the user to agree via another communication channel (e.g. in personal contact) as to who may interact at what time. Furthermore it is possible for the input devices to have to request control (in addition to the first solution) so that the application recognizes which amongst the external input devices is the topmost priority (the lead).

Preferably there is provision for all connected input and output devices, including the original user interface of the application, to be informed by showing a window on the interface if the status of another input and output device changes (if for example an input and output device is switched off).

In accordance with one aspect of the invention the adapter module and the control module interact with one another such that, for each state of the medical technology device or at each point in time, an input and output context is synchronized with a device context of the medical technology device, so that the medical technology device can be controlled via the external input and output device. Depending on the configuration of the controller system, it can be preset that external input and output devices can only be connected to the medical device or to its controlling application for specific sections of the control method (for the medical technology device) or for a specific time or under specific conditions (e.g. only at specific times or only in a specific, limited number). As soon as the application requests an input for control of the medical technology device, this device context (i.e. the requested input for example) is automatically transferred to the external input and output device and is interrogated there, for example in a field or in a separate window. Conversely (for data exchange from the I/O device (I—input, O—output) to the application) the following likewise applies: As soon as the dialog with the user for entering the requested data can be ended and all requested data has been entered via the user interface of the touchscreen, this input and output context is automatically forwarded via the application to the medical technology device for controlling said device. In accordance with the invention this thus makes context-sensitive control of the medical technology device (via the application) through the external touchscreen possible. This merely requires the installation of a control module on the medical technology device. The adapter module and the control module alternately inform each other about a changed context and, depending on state and situation of the medical technology device, update the user interface or the state of the device by gestures or interactions on the touchscreen of the external input and output device.

The controller system is context-sensitive. This means that all changes to the controller system and to its components, especially also a replacement of an input device or an external input and output device, are recognized and evaluated. If necessary the detected change can be presented on the connected input and output devices. “Context-sensitive” also means that the respective status of the application or of the medical technology device is mapped or implemented on the I/O device and vice versa, that the respective status of the I/O device (all displays and entries of the user) is notified to the application for processing, which subsequently controls the medical technology device in accordance with the commands. In other words the user changes the context of the system when he operates the application in a conventional manner (e.g. via the previously used I/O device of the application). This context change is then automatically mapped to the external input device and displayed accordingly. Conversely a context change which is triggered by the application (e.g. a request for user data is necessary and must be presented on the output device) is “copied” accordingly to the external device and the interface of the external device is updated (in the previous example: The user data is requested or can also be entered on the external device).

Depending on type and complexity of the medical technology device, the corresponding user interface with the input and output option must also be embodied more complex or less complex. This means that for specific medical technology devices there are preferred input and output devices and less suitable input and output devices. In this case the controller system, in accordance with one variant of the invention, additionally has a memory in which an assignment is stored which in each case assigns an application and/or a medical technology device one or more, possibly prioritized external input and output devices, with the assignment taking into account technical parameters of the medical technology device and/or of the input and output device. The assignment can be provided in the form of a mapping table or of another data structure directly at the medical technology device or within the controller system or on a separate memory entity to which the controller system has access. The data structure for the assignment given above can for example be embodied in the form of the table. For example it can be defined that for control of an MRT system only complex touchscreens with comprehensive functionality can be used, whereas for simple laboratory devices, which as a rule only require binary yes or no inputs, simple touchscreens can also be used, especially those such as are provided on a mobile radio device. The advantage of this is that the best-suited touchscreen can be selected for the respective application case as input and output device if a number of external input and output devices are connected to the device.

In an advantageous variant of the invention a number of external input and output devices can also be assigned to the controller system and switched in or connected for controlling the medical technology device. In accordance with one aspect it is possible for an external input and output device also to be able to control a number of applications and/or a number of medical technology devices. For example this control can be executed offset in time (in accordance with the time division multiplexing method for example). As an alternative the different applications or devices can also be accessed by switching the interface.

In accordance with an aspect of the invention there is provision for the controller system to automatically read in and evaluate the device parameters of the input and output device (especially if the said device has been registered) in order to be able to provide a device-specific functionality for the input and output device.

The above-mentioned object of the invention is also achieved by a method for context-sensitive control of a medical technology device which is operated and/or controlled via a computer-assisted application, with the application being involved in an exchange of data with a control module with the following steps:
Automatic detection of whether an external input and output device (I/O device, preferably with touchscreen) is located in the interface area of the control module
Automatic registration of the detected input and output device
Detection of a confirmation signal at the I/O device or by the application
Exchange of control data between the external input and output device and the control module for control of the medical technology device via the external input and output device.

In accordance with an advantageous development of the method described here there is provision for it to be able to be configured in a configuration phase when and under what conditions the automatic detection is to be executed. For example there can be provision for the detection model to be activated for automatic detection after each start of the application or after each startup of the input and output device in the interface area of the control module. As an alternative the automatic detection can be carried out after configurable time intervals and/or after configurable events.

The registration of an external input and output can be made dependent on a confirmation code. The confirmation code can comprise two sections:

A confirmation on the part of the external input and output device that the user of the input and output device confirms that he wishes to control the medical technology application with his device. On the other hand the confirmation on the part of the application can be requested, i.e. that the user at the medical application or at the medical technology device confirms that he declares as permissible and legitimizes control by the external, registered input and output device.

A further way of achieving the object is a non-transitory, computer-readable data storage medium encoded with programming instructions that form the adapter module and the control module, which are thereby embodied for installation on external input and output devices and on the application or on the medical technology device.

The adapter module and/or the control module can be provided as executable code. As an alternative they can be retrieved from a central entity for download.

### BRIEF DESCRIPTION OF THE DRAWINGS

FIG. 1 shows an overview-type schematic diagram of a control system for medical technology devices via external touch user interfaces in accordance with a preferred embodiment of the invention.

FIG. 2 shows a flow diagram according to an inventive method in accordance with an advantageous embodiment.

FIG. 3 shows a two-part schematic view of a context change for control of the medical technology device.

FIG. 4 shows a further example of a context change.

FIG. 5 shows a schematic overview diagram for control of a number of medical technology devices with an external touch user interface according to a preferred embodiment of the invention.

### DESCRIPTION OF THE PREFERRED EMBODIMENTS

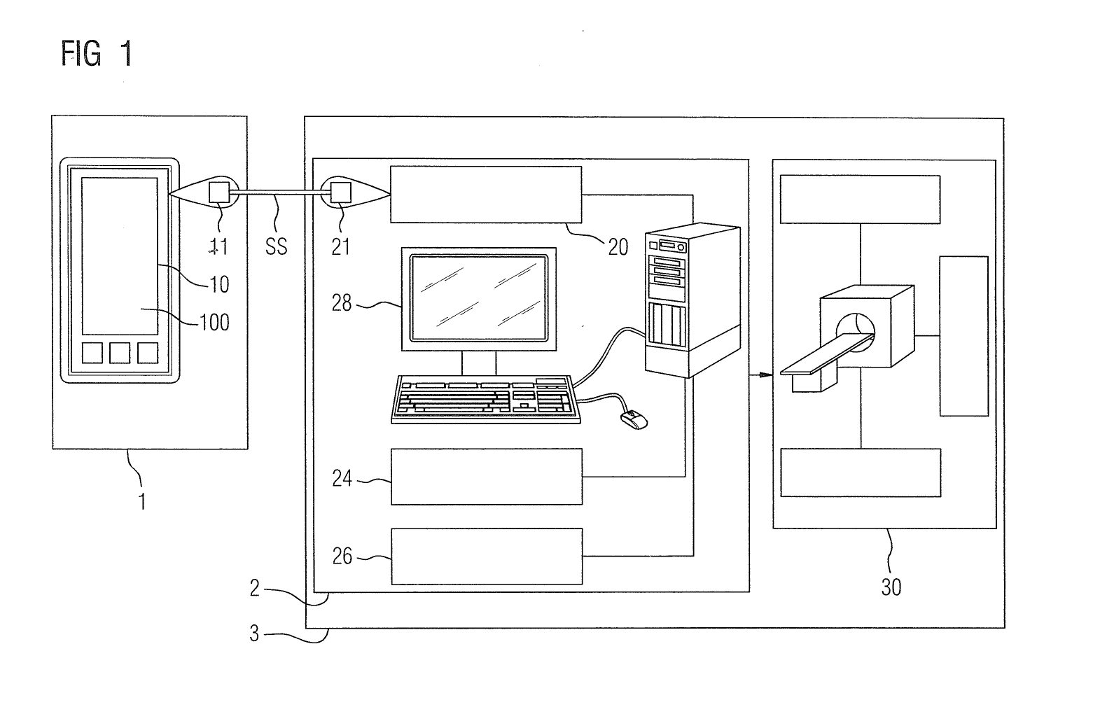

The invention will be explained in greater detail below on the basis of a preferred exemplary embodiment in conjunction with FIG. 1.

The electronic, context-sensitive control system comprises two separate, computer-based units or entities: An electronic device with a touchscreen 100 and separate therefrom a medical device system 3. Preferably the electronic device 1 and the device system 3 are not in direct, immediate connection (data link, communication link) with one another. They are merely exchanging data via their modules, especially via an adapter module 11 and via a control module 21. To this end an interface SS is provided between the adapter module 11 and the control module 21.

The medical device system 3 is computer-based and as a rule consists of a medical technology device 30, e.g. a laboratory device, an MRT device or an x-ray device, or a group of devices. This medical technology device 30 must on the one hand be operated and on the other hand be controlled. An application system 2 is provided for this purpose. The application system 2 is likewise computer-based and as a rule comprises a computer (workstation or a group of computers or a computer network) and can be based on different operating systems. The computer exchanges data with a monitor and further input and output devices, such as a keyboard and a mouse for example. As an alternative other input and output systems can also be provided here. Usually an application 20 runs on this application system 2 which is used for operating the medical technology device 30. The application A can for example be an application with which a patient couch of an imaging system (e.g. a CT system 30) is moved. Then the user can enter input parameters via the user interface, which define the start position to which the patient couch is to move. Likewise it is possible for example for him to define an end position into which the patient couch is to move as a target position after the end of the treatment. This is controlled by the application A. As an alternative it is likewise possible for the medical technology device 30 to be controlled via the application A. This is typically provided if the medical technology device 30 involves a nuclear resonance device which is controlled by entering measurement sequences. This can also be brought about via the application A.

In accordance with the invention the application system 2 and especially the application 20 is now expanded by the control module 21. Preferably the control module 21 is a software implementation which can be copied onto the application 20. The control module 21 is used so to speak as a converter to convert all input and output variables which the application 20 requires so that they can be presented and entered on the touchscreen 100 of the input and output device 10. For this purpose there is preferably provision for device parameters of the device 1 and especially of the touchscreen 100 to be forwarded to the control module 21 in advance (namely in a configuration phase), so that the control module 21 can undertake the implementation of the inputs and outputs as a result of this recorded data. As an alternative or cumulatively, application-specific parameters (comprising parameters of the application and parameters of the device to be controlled, e.g. “which input and output has taken place and in what form?”, “how large”, “which device” etc.) can be passed on by the medical technology device system 3 to the external touch device 1, in order to adapt the latter specifically to the requirements of the medical technology device system 3.

But it is not just the application 20 that is expanded, but in accordance with the invention an expansion is also provided on the electronic device 1 in the form of an adapter module 11. The adapter module 11 is preferably likewise a software implementation and can be copied onto the electronic device 1 as additional functionality. This can be carried out via a different interface to the interface SS between adapter module 11 and control module 21. The preferred option here is a mobile radio connection via which the electronic device 1 can retrieve and download the adapter module 11 from a central entity. Other communication channels are also conceivable however.

As well as other aspects, a core idea of the present invention is to be seen as a laboratory device 30 or an imaging system 30, in addition to a monitor 28 usually provided, which is used as the I/O device in controlling the device 30, being able to be connected to external input and output entity which has a touchscreen interface 100. The intended aim is to make the operation of the medical technology device 30 easier and enable it to be improved since known devices 1 already in operation can be used with corresponding touchscreen interfaces 100. The devices 1 are inventively merely to be equipped with an additional functionality which is provided by the adapter module 11.

The inventive concept is however not restricted to the connection of specific user interfaces. In addition to the connection of touchscreen interfaces (also called touch user interfaces) other user interfaces can be connected, for example normal graphical user interfaces (GUI), interfaces which allow windows or control via widgets as well as user interfaces for multipurpose operating systems or those with specifically designed switching surfaces, such as buttons, toolbars, slider controls, selection lists and other dialog windows which can be used to input user requests. In the preferred embodiment an input and output device 10 is used which comprises a touch-sensitive screen 100. As an alternative however more simple variants can also be used, for example command line interfaces (CLI), text user interfaces, but also speech-based user interfaces (e.g. Voice User Interfaces/VUI) or Tangible User Interfaces.

A significant advantage of the inventive solution comes to the fore in such cases in that input and output devices 10 that the user can operate well and knows in any event are also able to be connected, for example their mobile radio device 1 which has a corresponding touch-sensitive user interface 100. By expanding the known device 10 with the adapter module 11 it then becomes possible to take over specific control functions for the medical technology device 30. For example this device to be controlled involves visual diagnosis software such as is marketed by the applicant under the trademark Syngo.via®.

To avoid security gaps and to restrict non-legitimate input and output devices 10, there is provision in a preferred development of the invention that in a configuration phase all input and output devices 10 considered or all electronic devices 1 considered are registered. The registration procedure can for example be implemented by a flag being set in a data record of the device 1 or 10, which indicates that the respective device is registered. In an operating phase in which external input and output devices 10 are to be connected to the application system 2, a check can then be made as to whether the respective device 10 that is to be connected is also registered. Only devices 10 which have been registered in advance are approved for connection. The attempt to connect non-registered devices 10 results in an error.

In a variant there can be provision (which can, however, also be used in addition to that described here—i.e. combined) for a request to connect an external device 10 (even if this device is registered) to have to be confirmed by the application system 2. In other words the external input and output device 10 can only be connected and put into operation if a confirmation signal from an administrator or user is requested and detected by the application system 2, for example on the monitor 28, by way of a user interface. This confirmation signal request is usually initiated and processed by the control module 21. If the user does not enter a confirmation signal at the application system 2, the external touchscreen 100 also cannot be used for control of the medical technology device 30.

To securely avoid the infiltration of malware through the external input and output device 10 into the application system 2, in accordance with an advantageous variant of the invention there is no provision for a direct communication link and thus also no exchange of data between the external input and output device 10 and the medical technology device system 3 or the application system 2. Only the predefined interface SS exists between adapter module 11 and control module 21. The interface SS can be preconfigured so that only permitted datasets are transmitted. Other datasets are excluded from the transmission.

The application system 2 can be further expanded in accordance with a variant of the invention. For example it is possible to provide a detection module 24 which exchanges data via a corresponding interface with the computer system of the application system 2. The detection module 24 is used to automatically detect whether an external input and output device 10 is located in the interface area of the control module 21. This can be done for example via a mobile radio connection. Depending on the configuration of the controller system different variants are now conceivable. On the one hand it is possible that after detection of such an input and output device 10 in the interface area, a registration of the device 10 is initiated automatically. On the other hand it is possible for the detection of the device 10 to first be shown on a monitor 28 of the application system 2 in order to inform the user about said detection. It is also possible for a corresponding message to be displayed (in a pop-up window for example) on the electronic device (e.g. the mobile radio device) showing that this device is located in the interface area of the control module 21 and thus can also potentially control the medical technology device 30.

Depending on the application 20 or the embodiment or operation of the device 30, the user interface must be designed to different levels of complexity. With simple devices which merely requires the operation of different keys, the user interface 100 can be designed to be very simple, while with complex systems (e.g. MRT Systems 30) the user interface must be designed to be very comprehensive. Therefore it is evident that for the respective application 20 or the respective control situation of the medical technology device 30 different input and output devices 10 are suitable or come into consideration. For example the control of an MRT system 30 can rarely be carried out by the touchscreen 100 of a mobile radio device 1. In order to be able to establish in this case an optimum possible assignment between input and output device on the one hand and application 20 or medical technology device 30 on the other hand, the inventive control system can in accordance with a preferred embodiment of the invention be expanded by an assignment functionality. For this purpose the application system 2 accesses a memory 26. The memory 26 can either be part of the application system 2 or can be a separate entity exchanging data with the application system 2. An assignment is stored in the memory containing a best-case mapping between different classes of input and output devices 10 and different classes of medical technology devices 30. This assignment can also be even more finely granulated so that, in addition to the class of the input and output devices 10, further device parameters are also taken into account, such as the size of the touchscreen 100 for example, the resolution of the icons able to be displayed on the touchscreen 100, the size of the mobile radio device 1, its operating elements, further device parameters such as the processing power, interface connection options etc. Likewise device-specific parameters can also be taken into consideration, such as the class of the medical technology device for example, the type of the application 20, the use or the current operation of the medical technology device 30, computer resources of the application system 2, parameters (resolution, size etc.) of the previously connected monitor 28 etc. In this context it is to be taken into consideration that these parameters, comprising external parameters which relate to the external input and output device 10 and application parameters which relate to such parameters as concern the application system 2, involve exclusively technical parameters. These parameters are preferably detected by the controller system. This advantageously takes place in a configuration phase. They can also be exchanged by the interface SS to make settings on the touchscreen 100.

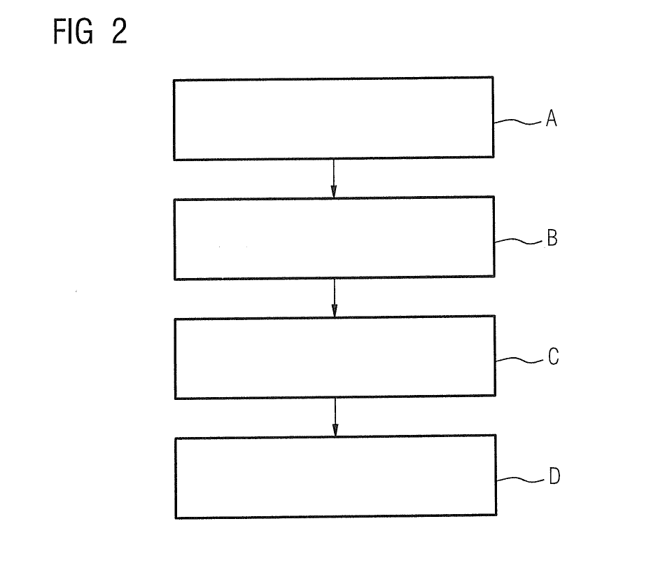

A normal execution sequence of the inventive control method is depicted below with reference to FIG. 2.

In step A an automatic detection of all external input and output devices 10 which are located in the interface area of the control module 21 takes place. If no such input and output devices 10 can be found, the method ends here. This detection step can be repeated based on time or on events.

Otherwise, in step B, the respective detected input and output device 10 is automatically registered. Different registration procedures (preferably comprising authentication methods, e.g. in accordance with the challenge-response method) can be provided for this purpose. Otherwise the registration can also be carried out by determining registration signals which are exchanged between the adapter module 11 and the control module 21 by the interface SS and processed on the control module 21 for example.

After the execution of step B two variants are basically possible. On the one hand it is possible to go directly on to step D, on the other hand it is possible for the method to be continued with step C. In step C (which is thus optional) a confirmation signal is detected. The confirmation signal is used to ensure that a connection of the external input and output device 10 is actually to be carried out. Once again different variants are now able to be implemented for this purpose. On the one hand it is possible for the confirmation signal to be exclusively entered at the external input and output device 10. On the other hand the confirmation signal can be entered exclusively at the application system 2 via the monitor 28 for example. It is also possible to provide a combination of the two options given above, with which security can be increased even further, since two separate inputs are necessary.

In step D the actual connection is carried out. This is done by the exchange of control data between the adapter module 11 and the control module 21. Advantageously, with the inventive control system or method, a change of context can be recognized automatically, which automatically leads to the updating of the valid user interactions or to the updating of a display on the touchscreen 100. An adaptive user interface can thus be provided which evaluates contexts and updates itself automatically, depending on the evaluated context.

The connection of the external touchscreen 100 can be ended by different measures. It is possible for the interface SS to be interrupted/disconnected. Moreover, an end signal entered by the touchscreen 100 can lead to the ending of the connection. Otherwise an end signal can also be entered at the application system 2.

In accordance with a variant the control module 21 can also be expanded by an activation functionality. This updating functionality can be implemented by a switch. This is used to switch the control module 21 on or off. The switching on or switching off of the control module 21 enables the connectability of external input and output devices 10 to be activated or deactivated in a central manner. This has the advantage that the control functionality is able to be activated and deactivated in a central manner. Usually the activation or deactivation signal is entered on the monitor 28 of the application system 2. As an alternative this activation functionality can also be transferred to the electronic device 1.

Basically a number of mobile radio devices 1 with touchscreens 100 can be connected to the application system 2. For this purpose either the same interface SS (e.g. mobile radio link or Bluetooth) can be used, or a device-specific interface. With such multi-device control there is usually provision for the previous input and output devices 10 to be informed about the connection of a new external input and output device 10. Originally only the monitor 28 is provided as output device (in addition to keyboard and mouse for example) which serves as an output device for the application 20. Depending on the application, the monitor 28 can involve usual graphical user interfaces. As an alternative a touchscreen monitor can also already have been provided here. As soon as an external input and output device 10 is now connected with the inventive method, this is displayed on the monitor 28. For connection of a second external input and output device 10 this is then displayed on the two previous input and output devices. The display can either be carried out directly by a pop-up window appearing or can be transferred via another channel (e.g. via e-mail) to the respective user of the device.

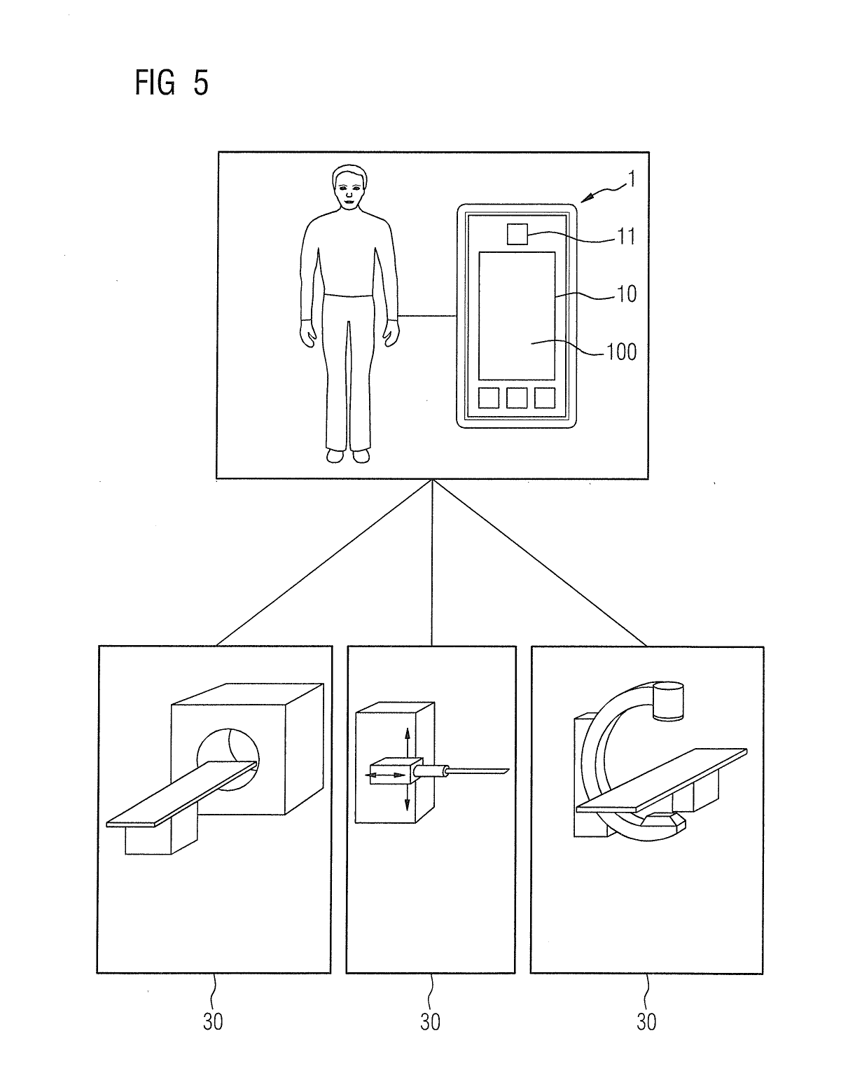

Conversely a plurality of medical technology devices 30 can also be controlled by an external input and output device 10. This is shown schematically in FIG. 5. Here a user's mobile radio device 1 is used to control a magnetic resonance system 30, an injector 30 and a C-arm x-ray device 30. It is obvious that the touchscreen 100 must have a correspondingly complex functionality available to it. Tablets (tablet PC), smartphones with a very large touchscreen 100 or touchscreens 100, as are currently used in kiosk systems, come into consideration for this purpose.

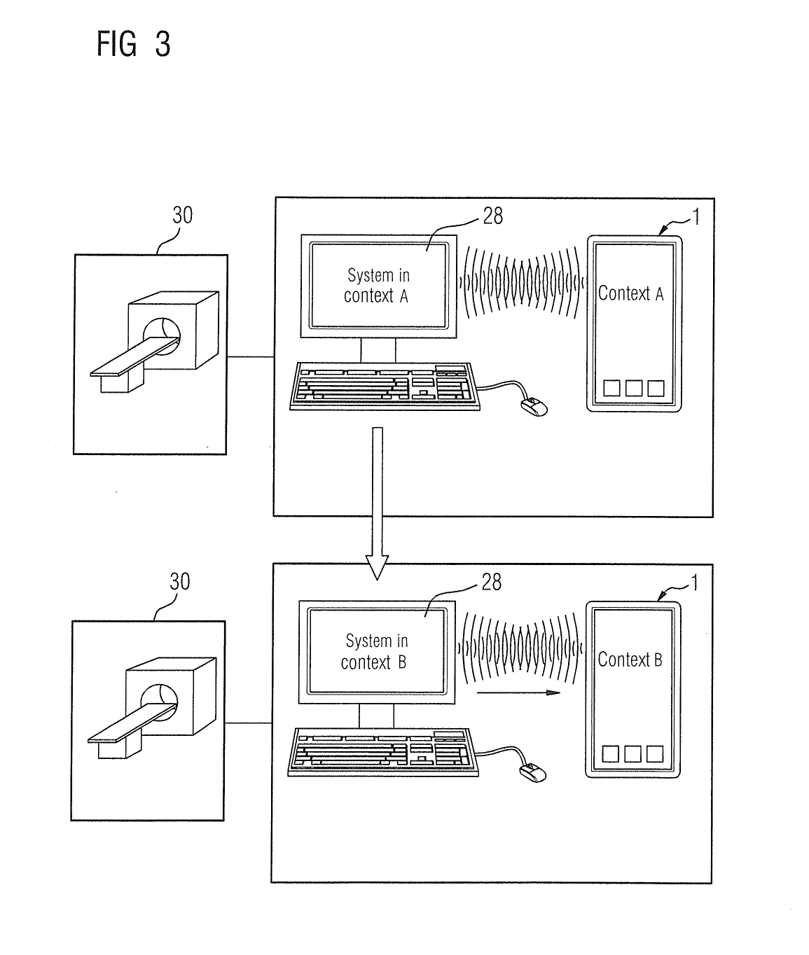

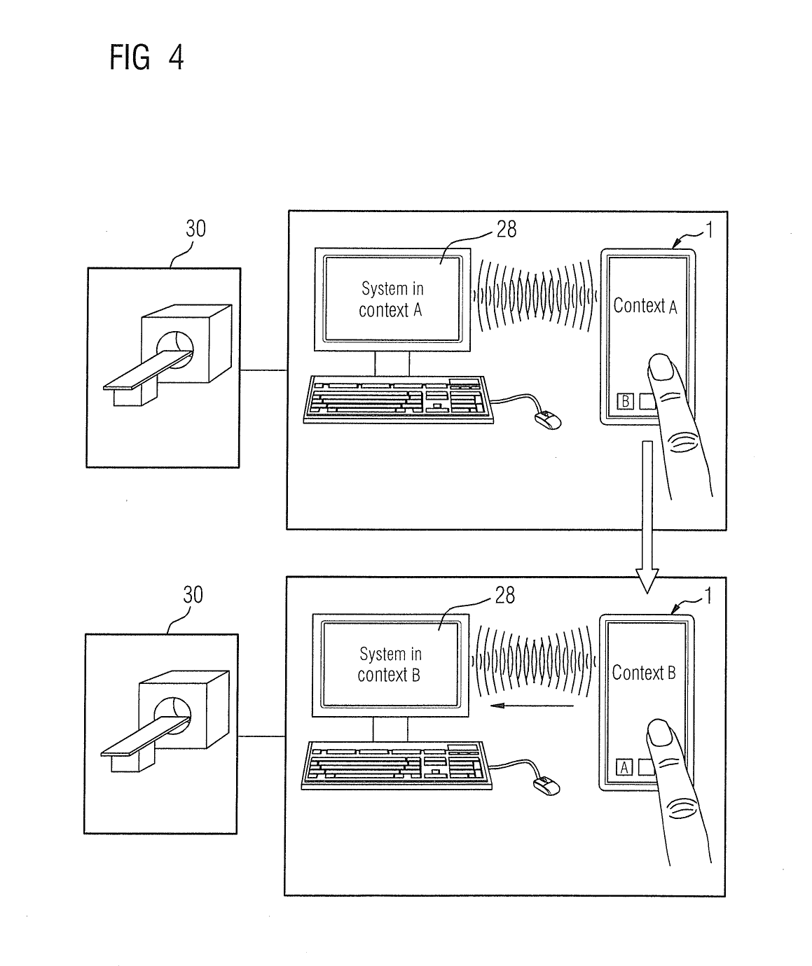

The context-sensitivity of the inventive control system is explained below in greater detail with reference to FIGS. 3 and 4.

FIG. 3 shows the case in which the application system 2, in conjunction with the respective medical technology device 30, changes its state or its context from context A to context B and the external touchscreen interface 100 of the external input and output device 10 recognizes this and adapts its interface accordingly. If for example the application system 2 is intended for control of a patient couch of an MRT system 30 (this is intended to be indicated schematically in FIG. 3 by the inclusion of the MRT device 30), then for example a change of context from A→B can show that the patient couch has been moved from a first position to a second position. This context change is communicated by the transmission of control data via a wireless interface SS to the external input and output device 10. The changed context B is shown in the lower section of FIG. 3. The MR device 30 is thus now situated in context B (e.g. Patient couch has been moved to the second position). The external input and output device 10 now recognizes this changed context B and adapts its touchscreen interface 100 accordingly, by displaying other dialog fields for example. In the context B only the interactions permissible in this context B are displayed on the touchscreen 100. Other dialog fields which are not relevant in context B do not reach the display.

Conversely a user input on the external input and output device 10 can also bring about a context change. This is described in greater detail below with reference to FIG. 4.

FIG. 4 is also divided into two sections. Located in the upper section is the diagram of the external input and output device 10 and of the application system 2 in context A. Because of a user input on the external input and output device 10, especially on the touchscreen 100, the context is now changed: from context A→context B. This context change is recognized by the controller system. This is shown in the lower section of FIG. 4. The user changes the common text by a user input. This is indicated in FIG. 4 by the schematic representation of a fingerprint on the touchscreen 100. The context is thus changed in the external input and output device from A to B. The system recognizes this and transfers corresponding control data via the interface SS. The application can subsequently control the medical technology device 30 in the appropriate manner. If for example the user input on the touchscreen 100 relates to the command “move patient couch by 10 cm upwards and by half a meter to the left”, this control data is then transmitted via the interface SS to the application 20, which then for its part triggers this command and converts it into a device control measure. Corresponding commands for moving the patient couch are then triggered on the device 30.

Depending on the configuration of the controller system, there can be provision for the outputs of the application 22 to be carried out on all connected output devices 10, 28—in parallel so to speak. It is however also possible for the output (that is the presentation of user information for example) to be carried out just on the external device 10 (and not on the previously connected monitor 28). In respect of the inputs for the application 20 a synchronization is provided, so that no inconsistent systems states can be generated. For example the situation is excluded in which user inputs (e.g. through inclusion of specific dialog fields on one of the monitors) are shown on a number of output devices. If a first user on a first external input device 10 then makes another entry, such as the administrator at the application 20 for example, an inconsistent data input will exist. This is inventively avoided by it being determined from which input device the inputs are to be used. For example it can be set that on the connection of an external input and output device 10, exclusively the inputs of this external device 10 are to be used (and not for example those which are entered by the application 20). It could also be set that a specific pre-configured input and output device is used as the sole input device on detection of inconsistent inputs.

The context is thus dependent on the application 20 for control of the device 30. If the application 20 thus changes from a first context for detailed view of an element to a second context for an overview, this change of context is also made on the touchscreen 100 (from detailed view to overview). In addition the context can also be dependent on the inputs on an input device. If, for example, the user clicks on an overview presentation, the system then switches automatically from a detailed view to the overview presentation.

The present invention can be summarized as follows.

A mobile radio device with a touchscreen 100 is expanded by an adapter module 11 so that it can be used as an input and output device for an application 20. The application 20 for its part is modified by the implementation of a control module 21. The application 20 is used for operation or for control of an imaging medical technology system 30. The interface between adapter module 11 and control module 21 is preferably a mobile radio connection or another wireless connection, e.g. Bluetooth.

Although modifications and changes may be suggested by those skilled in the art, it is the intention of the inventors to embody within the patent warranted hereon all changes and modifications as reasonably and properly come within the scope of their contribution to the art.

We claim as our invention:

1. An assembly of an electronic, context-sensitive controller system for a medical technology device, comprising:
at least one external input and output device with a touchscreen user interface, comprising an adapter module;
a medical technology device, operated and/or controlled via a computer-assisted application, with the application exchanging data with a control module; and
an interface between the adapter module and the control module configured to exchange control data for control of the medical technology device via the touchscreen user interface of the external input and output device.

2. The assembly as claimed in claim 1 comprising:
a detection module configured to automatically detect an external input and output device which is located in the interface area of the control module and, if such a device is detected, to automatically bring the input and output device into registration with each other.

3. The assembly as claimed in claim 2, wherein said detector device is configured to detect a change to components of the controller system, including a replacement of the input and output device, and to automatically evaluate said change.

4. The assembly as claimed in claim 1 wherein the adapter module and the control module are configured to interact so that, for each state or at each point an input context is reconciled with a device context, to allow the medical technology device to be controlled via the touchscreen user interface of the external input and output device.

5. The assembly as claimed in claim 1, wherein said interface is configured to allow a plurality of devices, including external input and output devices to also be connected in parallel.

6. The assembly as claimed in claim 1 comprising a memory in which an assignment is provided in which a respective application and/or a device are assigned one or more, prioritized, external input and output devices, wherein the assignment takes account of technical parameters of the medical technology device and/or of the input and output device.

7. The assembly as claimed in claim 1, wherein the interface is configured for exchange of data between the adapter module and the control module is a wireless connection selected from the group consisting of an interface via an Internet protocol, a wireless connection, an infrared interface, a Bluetooth interface.

8. The assembly as claimed in claim 1, wherein said interface is configured to synchronize a plurality of input and output devices for control of the medical technology device.

9. The assembly as claimed in claim 1, wherein the external input and output device is configured to also control a number of applications and/or medical technology devices.

10. The assembly as claimed in claim 1, wherein the external input and output device is embedded in a mobile radio device.

11. The assembly as claimed in claim 1, wherein said controller system is configured to automatically read in and evaluate device parameters of the input and output device and/or device parameters of the medical technology device or of an application system, in order to provide a device-specific control functionality for the input and output device.

12. A method for context-sensitive control of a medical technology device, which is operated and/or controlled via a computer-assisted application, wherein the application exchanges data with a control module, with the following method steps:
automatically detecting whether an external input and output device is located in the interface area of the control module;
automatically bringing the detected input and output device into registration with each other;
recording a confirmation signal;
exchanging control data between the external input and output device and the control module for control of the medical technology device via the external input and output device.

13. The method as claimed in claim 12, comprising implementing the automatic detection after each start of the application, after the input and output device is started up or after introduction of the input and output device into the interface area of the control module and/or after configurable time intervals and/or after the occurrence of a configurable event.

14. The method as claimed in claim 12, wherein a confirmation code is requested on the previous input and output device if a further external input and output device is detected and/or registered.

15. A non-transitory, computer-readable data storage medium encoded with programming instructions, said storage medium being loaded into a computerized control unit of a medical technology device, said programming instructions causing said control unit to:
automatically detecting whether an external input and output device is located in the interface area of the control module;
automatically bringing the detected input and output device into registration with each other;
recording a confirmation signal;
exchanging control data between the external input and output device and the control module for control of the medical technology device via the external input and output device.
